(19) United States
(12) Patent Application Publication
(10) Pub. No.: US 2010/0296805 A1
(43) Pub. Date: Nov. 25, 2010

(54) CAMERA HOUSING HEATSINK BRACKET SYSTEM

(76) Inventor: Tony Mayer, Vancouver (CA)

Correspondence Address: Paul D. Gornall, Reg'd Patent & TM Agent;ELC Law Corp., 1400 -- 1500 W. Georgia St., Vancouver, BC, V6G 2Z6, omitted

(21) Appl. No.: 12/682,125

(22) PCT Filed: Oct. 9, 2007
(86) PCT No.: PCT/CA2007/001788

§ 371 Date: Jul. 19, 2010

(51) Int. Cl. G03B 15/03; H04N 7/18

(52) U.S. Cl. 396/155; 348/143; 348/E07.085

(57) ABSTRACT

This invention provides a surveillance camera-housing system that dissipates heat from components mounted to heatsink brackets having flanges that press against inner walls of a camera housing. This ensures high thermal conductivity from the heat generating LED and electronics circuit boards and provides an easy assembly and self-locking mechanism for multiple boards on which are mounted components such as illuminators and power supplies requiring heatsinks, allows for easy optical alignment of LED and cameras, and is suitable for use in rugged and vehicle mounted environments.

### BACKGROUND

This invention relates generally to the field of camera system housings and to the field of heat-dissipating technologies.

There are many different types of camera system housings including housings designed for a number of different purposes including indoor uses, outdoor stationary use, outdoor mobile use, weather-resistance, bullet proofing, and explosion resistance. Designing camera housings with these types of functionalities can present certain challenges because of the sensitivity of camera equipment including CCDs, filters, lenses, electronic circuitry, and illumination equipment. No matter what the intended use of the camera system, the camera housing must generally provide protection, stability, and heat dissipation to ensure the proper functioning of the camera system.

Cameras and related electronics and illumination devices generate heat, particularly for high-resolution night-time surveillance systems which require high-intensity illumination. This has become a significant constraint on the amount of power that can be packed in to a surveillance system. As a result of this, camera surveillance systems are often large and bulky. This is particularly true for surveillance systems which incorporate more than one camera and for those that use high-powered illuminators.

Other difficulties with existing camera housings include difficulty of manufacturing or assembly. Where many components are involved, they often have to be screwed, bolted, or soldered together. Some components may get in the way of others during the installation or assembly process. The process can thereby become very labor and machine intensive. There may also be difficulty with quality control, as complication in the manufacturing process can result in loosening or damaging the integrity of the camera housing or misalignment of the camera and LEDs Where camera system components need to be replaced, it is also more difficult to insert and remove them. Internals must often be moved to accommodate lens and camera adjustment.

In addition, complex mounting arrangements can make it difficult to establish proper alignment of the optical components including camera and LEDs difficult during manufacturing and servicing procedures.

### SUMMARY OF THE INVENTION

The present invention provides improved heat-dissipation functionality in a simple design that is also easier to manufacture and leads to greater ruggedness, durability, and quality as a final product. It accomplishes these objectives by utilizing fewer components, including a double ‘C-bracket’ component mounting system for the LEDs and power supply components. The ‘C-bracket’ which also performs as a heatsink due to its high thermal conductivity and pressure exerted on the inner walls of the camera housing, which is also formed as a heatsink Heat is conducted away from the LEDs, cameras, and electronics circuit boards through a self-locking mechanism that keeps the camera system components in place, properly aligned and ensures easy placement and replacement of those components. The system also provides built in optical alignment of components.

The system comprises at least one heatsink bracket having components mounted thereon that benefit from heat dissipation, the bracket having flanges that can be compressed for insertion into a heatsink housing and that can be released to press against inner portions of the heatsink housing.

In one preferred embodiment, a power supply component is mounted on a first heatsink bracket and an illuminator is mounted on a second heatsink bracket The illuminator comprises a bank of LEDs. The LEDs generate considerable heat, which must be dissipated to maintain optimal light output and life of the illuminator. The power supply can also generate considerable heat so it is important that the back bracket has a good thermal path as well.

Further preferred embodiments would include such a system in which:

a) the heatsink bracket comprises a heatsink middle portion on which is mounted a circuit board for components;
b) the first heatsink bracket is slid to an abutment on a wall adjacent to an end of the housing and thereby positions components mounted on the first heatsink bracket at a desired location within the housing;
c) the flanges on the first heatsink bracket are sized such that portions of the flanges adjoining a middle portion of a second heatsink bracket abut end portions of the flanges on the first heatsink bracket when the heatsink brackets are slid to an abutment on a wall adjacent to an end of the housing and thereby position components mounted on the respective heatsink brackets at a desired location within the housing;
c) a housing front frame with illuminator and camera window fits over a camera and an illuminator mounted on a heatsink bracket that has been slid into the housing;
d) the heatsink bracket is a C-bracket with resilient compressible flanges substantially perpendicular to a middle component board portion of the C-bracket;
e) the flanges, when released, abut and exert pressure on inner side walls portions of the housing;
f) flanges on a second heatsink bracket are beveled to fit against a corner angle on a first heatsink bracket for better securing of position and heat transfer;
g) one heatsink bracket is secured to another heatsink bracket with screws which pass through a face portion of one of the heatsink brackets and into a receiving collar on the other heatsink bracket, whereby flanges on one bracket are pulled into contact with a portion of the other bracket;
h) a rear panel seals the housing and secures in position respective heatsink brackets, in order to seal and secure components mounted on the heatsink brackets at a desired location within the housing.

### BRIEF DESCRIPTION OF THE DRAWINGS

FIG. 1 is a perspective view of the surveillance housing system before assembly.

FIG. 2 is a perspective view of the surveillance housing system with a first heatsink component board bracket's flanges squeezed into the housing.

FIG. 3 is a perspective view of the surveillance housing system with a second heatsink component board, on which is mounted an LED illuminator and a camera, having its flanges squeezed into the housing.

FIG. 4 is a front perspective view of the first and second heatsink brackets.

FIG. 5 is a rear perspective view of the first and second heatsink brackets.

FIG. 6 is a perspective view of surveillance housing system, completely assembled.

FIG. 7 is a top cross-sectional view of a heatsink bracket with its flanges compressed for insertion into the housing.

### DETAILED DESCRIPTION OF THE DRAWINGS

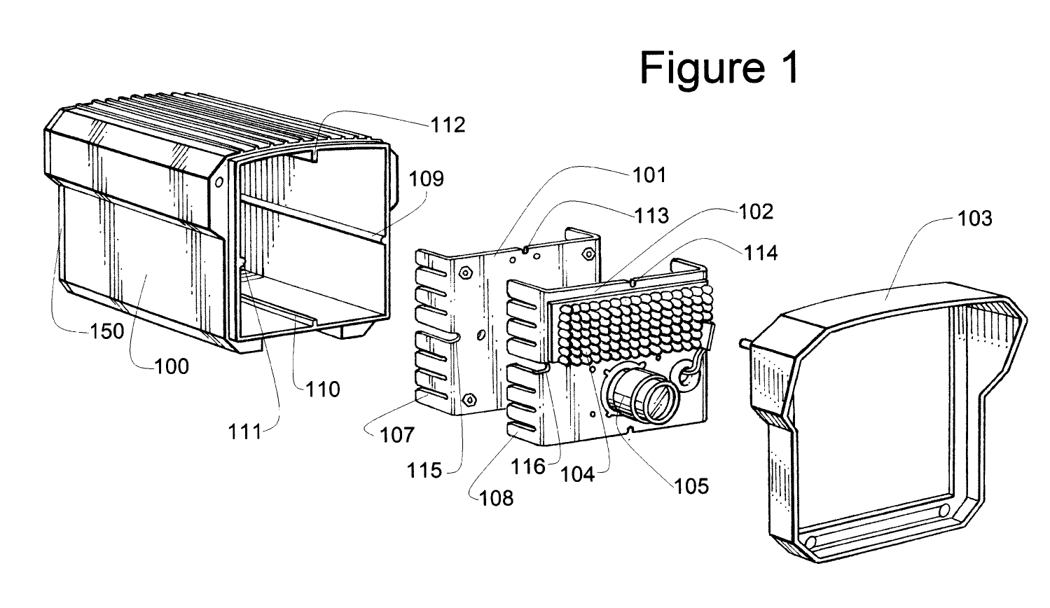

Referring to FIG. 1, a perspective view of the surveillance housing system before final assembly is shown comprising camera housing 100, first heatsink component board bracket 101, second heatsink component board bracket 102, and housing front frame 103 The first heatsink component board bracket 101 has flanges 107 on its sides which serve a dual function of providing alignment securing the heatsink bracket 101 into the heatsink camera housing and dissipating heat from the component board bracket 101 which can therefore support a high heat output component power supply or other high heat output components. The second heatsink bracket 102 has similar flanges 108 which dissipate heat from the high powered LED array 104 and the camera 105 as well as any high heat output power supply or camera circuitry on the reverse of the second heatsink component board bracket 102. Both heatsink component board brackets 101 and 102 will fit compactly into the heatsink housing 100 as the flanges 107 and 108 can be squeezed inward to fit inside the camera housing 100. From this view it is apparent that the inside of the heatsink housing 100 is relatively spacious for superior heat dissipation and ease of assembly. Heat is also dissipated from the housing front frame 103 and the housing rear panel 150.

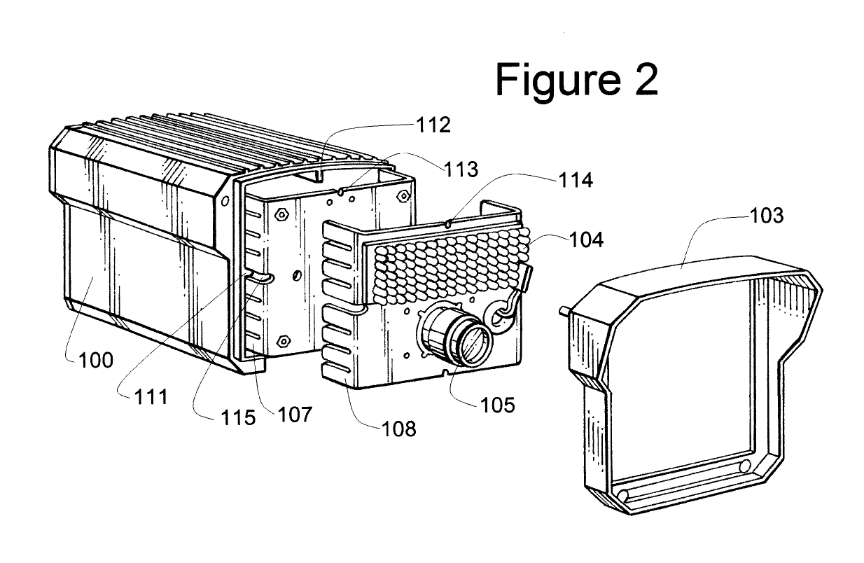

Referring to FIG. 2, a perspective view of the surveillance housing system 100 is shown with first heatsink component board bracket 101's flanges 107 squeezed into the heatsink housing 100 with the track 111 of heatsink housing 100 securing heatsink component board bracket 101 via groove 115. Tracks 109, 110, and 112 will also help to secure the heatsink component board brackets 101 and 102 as will the outward pressure from the flanges 107 and 108.

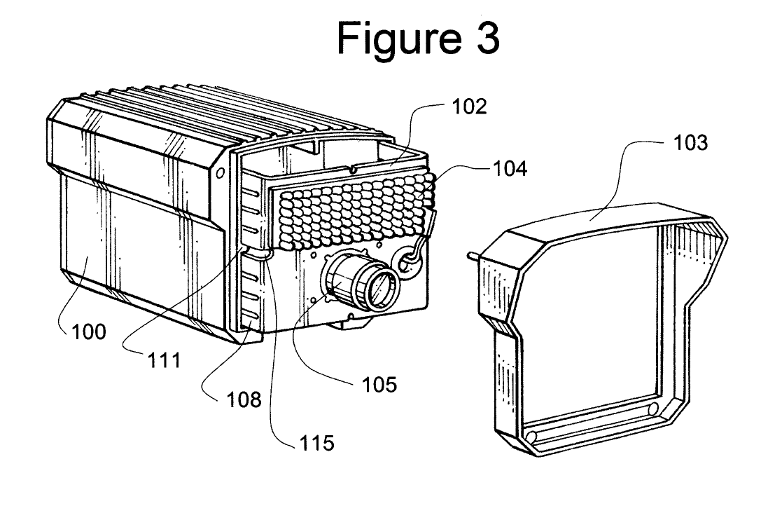

Referring to FIG. 3, a perspective view of the surveillance housing system is shown with second heatsink component board bracket 102, on which is mounted an LED illuminator array 104 and a camera 105, having its flanges 108 squeezed into the heatsink housing 100. The system has an efficient design with groove 115 fitting onto the same track 111 as did groove 114 on the first heatsink component board bracket. This allows for more efficient alignment and prevents the C brackets from canting or getting stuck while inserting or removing from the housing.

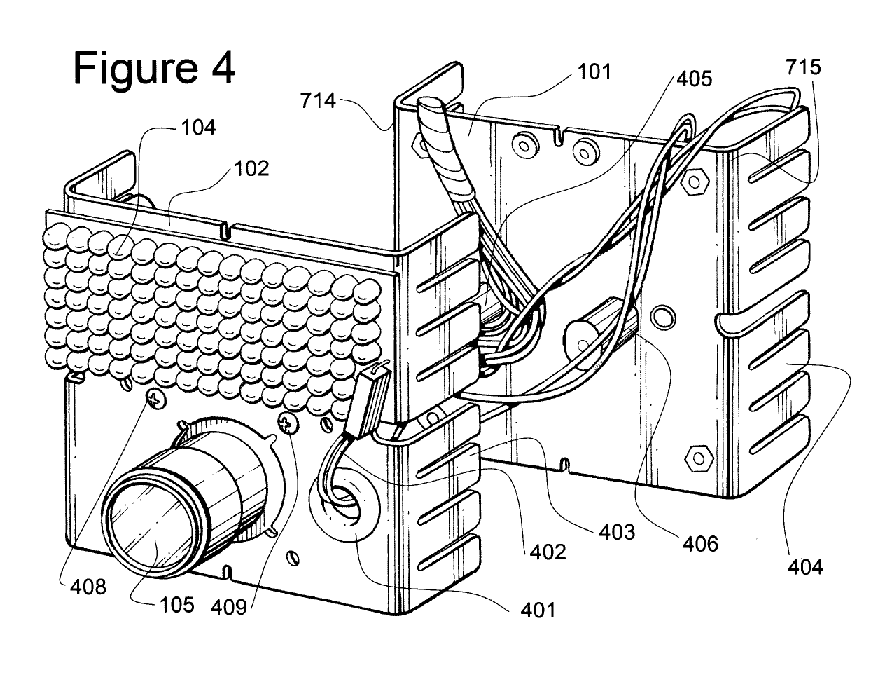

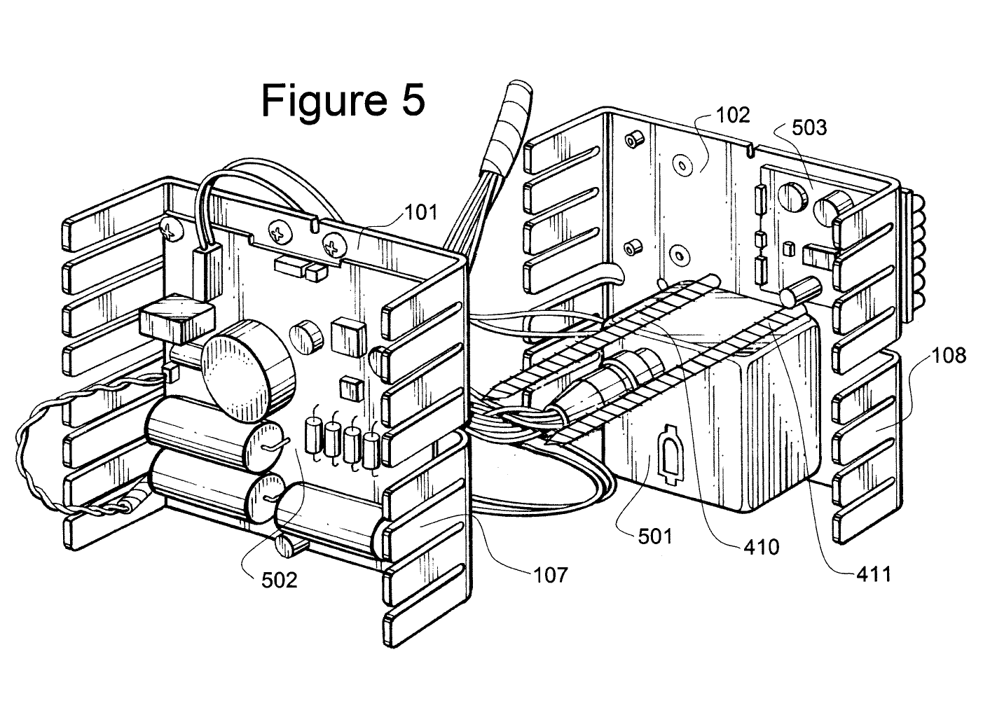

Referring to FIG. 4, a front perspective view of the first and second heatsink brackets is shown with heatsink component board bracket's 101 and 102 with the LED illuminator array 104 and the camera 105 affixed to the front of the second heatsink component board bracket 102. There is an opening 401 through which wires 402 connect the LED array to its power supply 502 which is on the reverse of the first heatsink component board bracket 101 The flanges 403 and 404 are shown from another angle and the first heatsink component board bracket 101 is shown from the front to have a bare, heat dissipating face. Optional threaded fastening collars 405 and 406 are affixed to the first heatsink bracket 101, and are adapted to receive optional screws such as 410 and 411 which pass through the second heatsink bracket 102, in order to secure the brackets together and eventually assist in holding the (front) second heatsink bracket 102 when it and the first heatsink bracket 101 are mounted in the housing. The screw head 408 for screw 411 is shown, as is screw head 409 for a like screw (410 in FIG. 5) to fit the threaded fastening collar 405. The curvatures 715 and 714 of heatsink bracket 102 are designed to fit tightly against beveled edges 710 and 711 respectively of heatsink bracket 101, illustrated in FIG. 7.

Referring to FIG. 5, shown is a rear perspective view of the first and second heatsink component board brackets 101 and 102 respectively The reverse of the heatsink component board brackets 101 and 102 is shown with their flanged edges 107 and 108 respectively which are compressed and exert lateral tension when heatsink component board brackets 101 and 102 are respectively mounted inside the camera housing. This lateral tension increases the heatsink capacity of the bracket which is crucial because the LED array 104 is surface mounted to the front of the second heatsink component board bracket and gives off a very significant amount of heat which can interfere with the functioning of the LEDs and even damage them permanently. The first heatsink component board bracket 101 serves to dissipate the tremendous heat given off by the power supply 502 as it converts AC power to DC power; this heat is efficiently dissipated through the heatsink material of the power supply 502 and the flanges 107 on its side. Optional screws 410 and 411 passing through heatsink bracket 102 screw into fastening collars 406 and 405 respectively mounted on heatsink bracket 101 to secure the brackets together within the housing. The securing screws 410 and 411 can thus pull and lock the two C-brackets 101 and 102 together increasing lateral tension for further improved heat transfer to the housing, and locking the two C-brackets together.

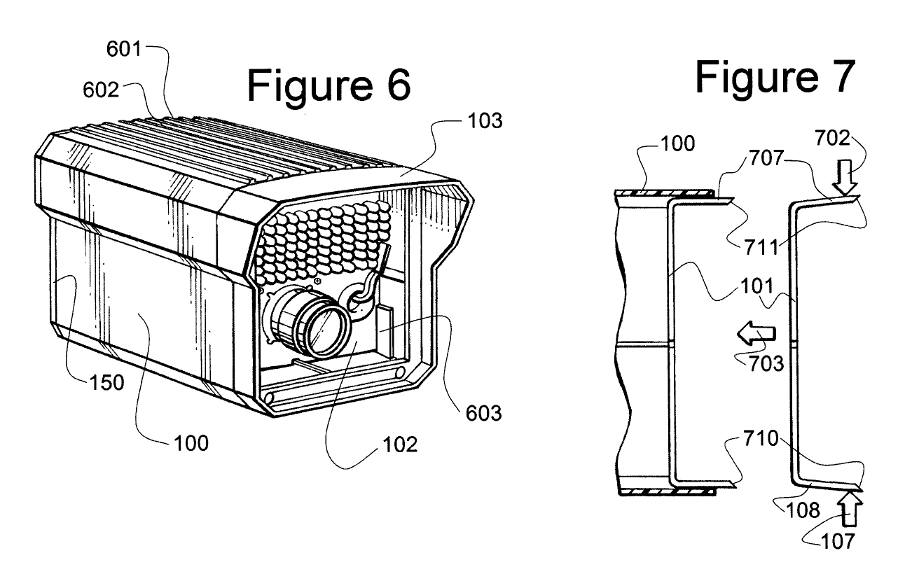

Referring to FIG. 6, shown is a perspective view of surveillance housing system, completely assembled. The top of the heatsink housing has ridges such as 601 and 602 which serve to increase its surface area thereby dissipating more heat. The top of the unit is the ideal place for such grooves due to the thermodynamic flows which cause heat to rise. Heatsink bracket 102 can be inserted in the housing from the rear and positioned in place by abutments such as 603 on an inner wall of the housing 100. Alternatively, depending on the desired position for components on the heatsink bracket 102 may be positioned by abutment with the housing front frame 103, as heatsink bracket 101 (shown in FIGS. 1-5) or secured by abutment with the housing rear panel 150.

Referring to FIG. 7, shown is a top cross-sectional view of a heatsink bracket with its flanges compressed for insertion into the housing. This is a sequence diagram beginning on the right with heatsink component board bracket 101 then being placed into the housing 100. As this happens flanges 107 and 707 are pressed inward at 701 and 702 respectively so that they can slide in the direction of 703 into the housing 100. Inside the housing, the flanges 108 and 707 are compressed, exerting pressure on the housing 100 which helps to secure them in place and dissipate heat more efficiently. The beveled edges 710 and 711 of the flanges i.e. 707 on heatsink bracket 101 are designed to ensure a tighter fit against heatsink bracket 102 (shown in FIG. 4, at 715 and 714 respectively).

We claim:

1. A surveillance housing system comprising at least one heatsink bracket having components mounted thereon that benefit from heat dissipation, the bracket having flanges that can be compressed for insertion into a heatsink housing and that can be released to press against inner portions of the heatsink housing.

2. The surveillance housing system of claim 1, in which a camera and illuminator are mounted on a first heatsink bracket, to provide easy and positive optical alignment.

3. The surveillance housing system of claim 2, in which a power supply component is mounted on a second heatsink bracket.

4. The surveillance housing system of claim 3, in which the illuminator comprises a bank of LEDs.

5. The surveillance housing system of claim 1, in which the heatsink bracket comprises a middle portion on which is mounted a circuit board for components.

6. The surveillance housing system of claim 1, in which the first heatsink bracket is slid to an abutment on a wall of the housing and thereby positions components mounted on the first heatsink bracket at a desired location within the housing.

7. The surveillance housing system of claim 3, in which the flanges on the first heatsink bracket are sized such that portions of the flanges adjoining a middle portion of a second heatsink bracket abut end portions of the flanges on the first heatsink bracket when the heatsink brackets are slid to an abutment on a wall adjacent to an end of the housing and thereby position components mounted on the respective heatsink brackets at a desired location within the housing.

8. The surveillance housing system of claim 7, in which the flanges on the second heatsink bracket are sized such that portions of the flanges adjoining a middle portion of a first heatsink bracket abut end portions of the flanges on the second heatsink bracket when the heatsink brackets are slid to an abutment on a wall adjacent to an end of the housing and thereby position components mounted on the respective heatsink brackets at a desired location within the housing.

9. The surveillance housing system of claim 7, in which a housing front frame with illuminator and camera window fits over a camera and an illuminator mounted on a heatsink bracket that has been slid into the housing.

10. The surveillance housing system of claim 1, in which the heatsink bracket is a C-bracket with resilient compressible flanges substantially perpendicular to a middle component board portion of the C-bracket.

11. The surveillance housing system of claim 10, in which the flanges, when released, abut and exert pressure on inner side walls portions of the housing.

12. The surveillance housing system of claim 1, in which flanges on a second heatsink bracket are beveled to fit against a corner angle on a first heatsink bracket for better securing of position and heat transfer.

13. The surveillance housing system of claim 1, in which one heatsink bracket is secured to another heatsink bracket with screws which pass through a face portion of one of the heatsink brackets and into a receiving collar on the other heatsink bracket, whereby flanges on one bracket are pulled into contact with a portion of the other bracket in order to increase lateral tension for further improved heat transfer to the housing, in addition to locking the heatsink brackets together.

14. The surveillance housing system of claim 1, in which complementary grooves and tracks respectively on the heatsink brackets and walls of the housing provide for efficient alignment of the heatsink brackets within the housing, preventing them from canting or getting stuck during insertion or removal from the housing.

15. The surveillance system of claim 1, in which a rear panel seals the housing and secures in position respective heatsink brackets, in order to seal and secure components mounted on the heatsink brackets at a desired location within the housing.

16. The surveillance housing system of claim 4, in which:
a) the heatsink bracket comprises a heatsink middle portion on which is mounted a circuit board for components;
b) the first heatsink bracket is slid to an abutment on a wall adjacent to an end of the housing and thereby positions components mounted on the first heatsink bracket at a desired location within the housing;
c) the flanges on the first heatsink bracket are sized such that portions of the flanges adjoining a middle portion of a second heatsink bracket abut end portions of the flanges on the first heatsink bracket when the heatsink brackets are slid to an abutment on a wall adjacent to an end of the housing and thereby position components mounted on the respective heatsink brackets at a desired location within the housing;
c) a housing front frame with illuminator and camera window fits over a camera and an illuminator mounted on a heatsink bracket that has been slid into the housing;
d) the heatsink bracket is a C-bracket with resilient compressible flanges substantially perpendicular to a middle component board portion of the C-bracket;
perpendicular to a middle component board portion of the C-bracket;
e) the flanges, when released, abut and exert pressure on inner side walls portions of the housing;
f) a top of the housing has ridges for increased surface area to dissipate more heat from inside the housing.

17. The surveillance housing system of claim 4, in which:
a) flanges on a second heatsink bracket are beveled to fit against a corner angle on a first heatsink bracket for better securing of position and heat transfer;
b) one heatsink bracket is secured to another heatsink bracket with screws which pass through a face portion of one of the heatsink brackets and into a receiving collar on the other heatsink bracket, whereby flanges on one bracket are pulled into contact with a portion of the other bracket, in order to increase lateral tension for further improved heat transfer to the housing, in addition to locking the heatsink brackets together;
c) complementary grooves and tracks respectively on the heatsink brackets and walls of the housing provide for efficient alignment of the heatsink brackets within the housing, preventing them from canting or getting stuck during insertion or removal from the housing.

18. The surveillance housing system of claim 16, in which:
a) flanges on a second heatsink bracket are beveled to fit against a corner angle on a first heatsink bracket for better securing of position and heat transfer;
b) one heatsink bracket is secured to another heatsink bracket with screws which pass through a face portion of one of the heatsink brackets and into a receiving collar on the other heatsink bracket, whereby flanges on one bracket are pulled into contact with a portion of the other bracket, in order to increase lateral tension for further improved heat transfer to the housing, in addition to locking the heatsink brackets together;
c) complementary grooves and tracks respectively on the heat sink brackets and walls of the housing provide for efficient alignment of the heatsink brackets within the housing, preventing them from canting or getting stuck during insertion or removal from the housing;
d) a rear panel seals the housing and secures in position respective heatsink brackets, in order to seal and secure components mounted on the heatsink brackets at a desired location within the housing.
